(19) United States
(12) Patent Application Publication
(10) Pub. No.: US 2008/0071900 A1
(43) Pub. Date: Mar. 20, 2008

(54) Device and a method for communicating in a network

(75) Inventors: Artur Hecker, Paris (FR); Erik-Oliver Blass, Karlsruhe (DE); Houda Labiod, Montrouge (FR)

Correspondence Address: OLIFF & BERRIDGE, PLC, P.O. BOX 320850, ALEXANDRIA, VA, 22320-4850, US

(73) Assignees: WAVESTORM, Paris (FR); GROUPES DES ECOLES DES TELECOMMUNICATIONS ECOLE NATIONALE SUPERIEURE DES TELECOMMUNICATIONS, PARIS (FR)

(21) Appl. No.: 11/898,859

(22) Filed: Sep. 17, 2007

Related U.S. Application Data
(63) Continuation-in-part of application No. PCT/FR2006/000552, filed on Mar. 13, 2006.

(30) Foreign Application Priority Data
Mar. 16, 2005 (FR) 05 02584

(51) Int. Cl. G06F 15/173; G06F 17/30

(52) U.S. Cl. 709/223; 707/104.1

(57) ABSTRACT

A method of managing a communication network comprising a control plane and a network plane, the network comprising nodes and physical connections of the nodes, each of a plurality of nodes being a logical network device, supporting a control plane portion in the control plane and a network plane portion in the network plane, in which method, the control plane portions of the logical network devices form a logical network in a peer to peer fashion, and control data necessary for administering the communication network and/or for managing users of the communication network is contained in at least one database distributed between at least a plurality of control plane portions of the network devices forming the logical network.

This application is a continuation in part of PCT APPlication WO 2006/097615 A1 filed on Sep. 17, 2007

The present invention relates to the field of communicating in a network, and to the field of network administration, for example for managing access control and managing equipment installed in a communications network.

### BACKGROUND

At present, in order to enable a network to be administered, various industrial standards and technologies are in use, such as for example architectures based-on simple network management protocol (SNMP) or authentication/authorization/accounting (AAA), well known to the person skilled in the art.

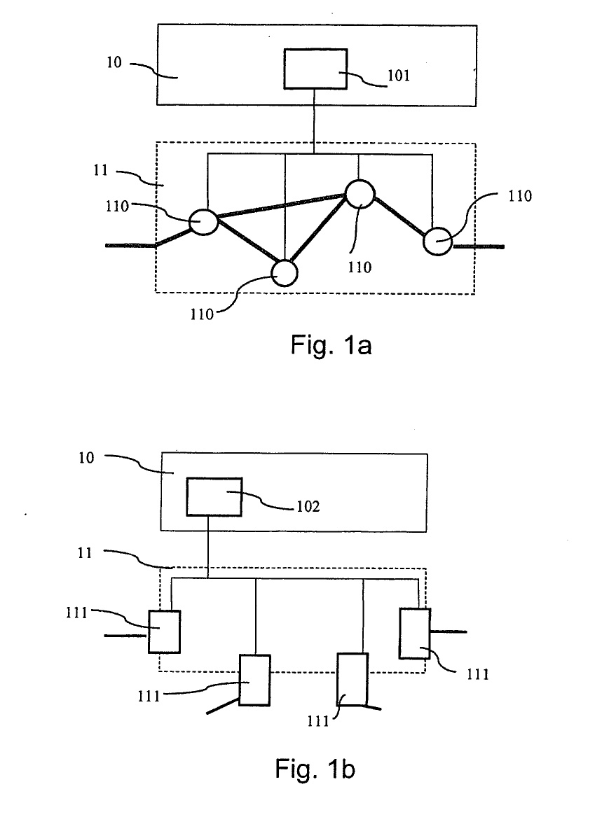

FIG. 1a shows a network architecture complying with the SNMP standard. That standard defines a network manager infrastructure implementing the agent-manager communication model, known to the person skilled in the art. In such a model, the agents (110) installed in pieces of equipment send reports to a central instance called the “manager”. The manager uses the reports to construct an image of the overall situation of the network. SNMP also makes it possible to change certain variables defined in the management information base (MIB).

In the field of network administration, a distinction can be drawn between three portions in a network: the activity or business plane; the control or management plane (10); and the network plane (11). The business plane is sometimes non-existent or coincides with the control plane (10).

Both the control plane (10) and the management plane (11) planes may logically speaking be strictly separated, i.e. the data may never be routed or forwarded from the network plane to the control plane and especially not the other way round. In that manner, users may not have any access to the control plane.

The separation may be logical, physical, or an arbitrary combination of both.

The business plane is used by the network administration to configure, control, and observe the behavior of the network. It also enables the administrator of the network to define basic standard behaviors of the network.

The network plane (11) contains pieces of equipment, e.g. routers, that provide the basic services in a network, for example transporting data coming from a user to the destination of said data via a router. The router is responsible for selecting the itinerary to be followed.

The control plane (10), also known as the management plane, is the intermediate plane between the business plane and the network plane. It enables network administration to be simplified by automating standard tasks, e.g. decision-making in standard situations previously defined by the administration of the network in terms of rules and strategies. The control plane centralizes the control of pieces of equipment in the network plane. Nevertheless, it can happen in practice that the control plane is incorporated in the business plane.

In the control plane of an SNMP type network, a central piece of equipment referred to as the network management station (NMS) (101), collects data from the SNMP agents (110) installed in the piece of equipment in the network plane. The NMS (101) then serves as a central control point for administration that is accessible from the business plane. In that model, administration does indeed exist, together with a variety of pieces of equipment to be managed: the administration of the network is thus centralized.

FIG. 1b shows a network architecture in compliance with the AAA standard that likewise presents centralized administration. The AAA standard defines an interface to a database, for example, and serves to authorize and authenticate utilization of a service and also exchanges of statistics about the utilization of the service to be authorized and authenticated. The AAA standard also defines an architecture and protocols enabling proofs of identity, allocated rights, and resource utilization statistics to be exchanged. The AAA protocol in the most widespread use is the standard known as IETF RADIUS. That protocol assumes a centralized infrastructure based on a client-server model known to the person skilled in the art. In that model, a central piece of equipment forming part of the control plane (11), referred to as the authentication server (AS) (102), is used to verify requests for access to services coming from other pieces of equipment in the network plane (11), commonly referred to as network access servers (NAS) (111) by the person skilled in the art. As a function of said verification and of local strategies, the AS (102) responds with an authorization message or an access refusal message. By way of example, typical NASes (111) are incoming servers, IEEE 802.11 access points, various network peripherals, and also services that verify user access authorization.

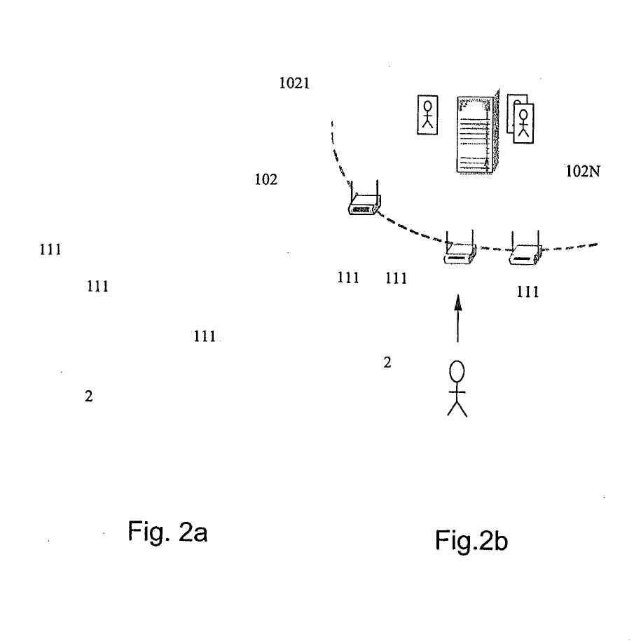

Thus, as shown in FIG. 2a, if the AS (102) does not respond because of a breakdown, then none of the NASes (111) administratively subject to that server can accept a new session. Sessions in existence on such access points will be interrupted on the next re-authentication. In general, a breakdown may be due to the AAA server being overloaded, for example. In addition, network overload depends on several parameters, for example the total number of users, the duration of a session defined by a user, the method of authenticating users, user mobility. This potential overload situation also emphasizes another key problem associated with such a centralized solution: extendibility or scaling, i.e. the ability to administer a network that is growing in terms of size. The centralized control point in such an architecture is nearly always either over- or under-dimensioned, thus representing either a waste of resources or a bottleneck, respectively. In that configuration, the overall reliability of the control plane thus depends directly on the reliability of the AAA infrastructure. The AAA infrastructure then becomes critical for overall network service.

One possible solution to the problem of scaling a network is to install additional AAA servers and to subdivide the network into subsets managed by respective AAAs of appropriate size. This is shown in FIG. 2b in which the left-hand access point authenticates on AAA server 1 (1021), whereas the other access points authenticate on AAA server N (102N). Modern AAA protocols, such as the standard RADIUS protocol, propose measures for interconnecting the “proxy” AAA server that enables such subdivision to be achieved without putting limits on user mobility: a user (2) having a profile managed by AAA server 1 (1021) may still access the service from any of the connected access points (111). Nevertheless, such a solution that consists in installing additional servers becomes very expensive in terms of maintenance and presents a control infrastructure that is considerably more complex.

Thus, all of those network administration solutions, and in particular concerning management and access control, are based exclusively on centralized architectures, i.e. management is performed by a single central piece of dedicated equipment, and that presents several major drawbacks, in particular in terms of robustness, cost, and scaling.

If the central piece of equipment introduced by SNMP or AAA architectures breaks down, e.g. a hardware, network, or electricity breakdown, then the service rendered by the network becomes immediately and completely inaccessible for all new users; sessions that are already open with connected users can no longer be extended after expiry, where the duration of a session is of the order of 5 minutes (min) to 10 min, for example, in the context of a wireless network.

In addition, as with all centralized solutions, an overload situation can arise due to a high level of network activity, e.g. too great a number of pieces of equipment (e.g. clients, agents) deployed in the network and subject to the same central piece of equipment. This piece of equipment then acts as a bottleneck and restricts potential for scaling the network. In the specific case of an AAA architecture, overloading can be due for example to the number of users, to the defined session duration, to the mobility of users, or indeed to the methods used for authenticating users. The need for a centralized piece of equipment does not enable natural growth of the network to be followed. For example, if a business seeks to deploy a small network to cover specific identified needs, the cost of such a network will be disproportionate to its return. Moving any centralized system to a different scale is difficult: it is naturally either over-dimensioned or under-dimensioned at some particular moment.

Furthermore, in terms of equipment costs, an installation requiring some minimum amount of security and network management implies that a centralized control system needs to be installed. Making the system reliable, the complexity of managing it, and of maintaining it, imply deploying human competences and forces as needed to enable networks to operate properly, and thus represent costs that are not negligible.

To sum up the technical properties and drawbacks of a centralized control architecture, it can be said that it is not well adapted to differing circumstances.

When installing large networks, the central control point or AS (102) in an AAA architecture can become a bottleneck and also represents an undesirable single point of failure. Installing a plurality of AAA servers authenticating via a common user database does not attenuate the problem of scaling and cost.

With small networks: centralized administration concepts are not well adapted to small installations having fewer than 50 access points. The main problem is the cost and the operation of a reliable central installation. Because of its flexibility of utilization, management generally requires in-depth knowledge of the network and competent administration. The administration effort and the additional cost in equipment, software, and maintenance are difficult to recoup in small installations. For example, it is difficult, particularly for small businesses, to make use of the presently-available access control solutions for wireless local area networks (WLAN): they are not sufficiently secure, or making them secure is unaffordable. That is why the IEEE 802.11i standard proposes a pre-shared key (PSK) mode for independent access points. Nevertheless, in that mode, it is practically impossible to offer access to occasional visitors or to different groups of users. In addition, if a WLAN installation based on the PSK mode is to be extended to a plurality of access points, the extension is achieved mainly at the cost of reduced security or else requires users to be allocated to predefined access points, thereby limiting mobility. Thus, the only alternative that exists in present centralized concepts consists in all new access points authenticating towards the first access point acting as a local AAA server and containing the user profiles. Nevertheless, although simpler to obtain in practice in a small network, that solution assumes that a central AAA server is installed, but with resources that are particularly limited. That solution is not easy to extend. In addition, presently-existing integrated AAA servers are voluntarily relatively simple and physically do not make available all of the functions of a dedicated AAA server.

If the network grows, problems arise in terms of extendibility and cost. With presently-available centralized architectures, continued growth of the network (e.g. due to the business developing) is difficult to follow. Installing an AAA server represents a considerable cost. In addition, a new AAA server is difficult to add to an already-existing infrastructure because of the new distribution of the database and the necessary confidence relationship. For example, if the user databases are completely replicated, it is necessary to make use of coherent mechanisms to ensure that the same content is to be found in all of the databases. This is difficult since modifications can be made to the various databases simultaneously. If the database is not replicated for each AAA server, each AAA server then becomes a weak point for all users managed in the database. Naturally, an undesirable compromise exists between the performance of the control plan and its complexity.

### SUMMARY

Examplary embodiment of methods consistent with principles of the present invention preferably may obviate one or more of the limitations of the related art and may provide a network capable of keeping up with growth in the administration capacity of the network, i.e. optimized scaling, making it easy to accept the addition of new points of access in a manner that is transparent for users, supporting user management, not requiring new constraints in terms of user mobility, i.e. each authorized user may be capable of connecting to each access point of the network, accommodating simplified management, not leading to constraints in terms of data rate or delays in transporting data, not imposing constraints in terms of network plane service.

Examplary embodiments of the invention propose a solution that may not decrease the performance of the network and that may not give rise to any point of weakness, and in which the impact of a partial breakdown is limited to the pieces of equipment that are faulty.

Examplary embodiments of the invention propose a solution providing AAA type user profile support, for example, with identical or equivalent user management possibilities, so that each user may have the possibility of being able to access any portion of the network.

Examplary embodiments of the invention provide a method of managing a communication network comprising a control plane and a network plane, the network comprising nodes and physical connections of the nodes, each of a plurality of nodes being a logical network device, supporting a control plane portion in the control plane and a network plane portion in the network plane, in which method, the control plane portions of the logical network devices form a logical network in a peer to peer fashion, and control data necessary for administering the communication network and/or for managing users of the communication network is contained in at least one database distributed between at least a plurality of control plane portions of the network devices forming the logical network.

Some of the nodes may be network devices. Other nodes may be user equipment for granting access, third party equipment, non participating and other devices, computers, and/or elements etc.

The devices may be computers or network equipment, network elements, such as routers, switches, hubs, firewalls, anything that would be understood as a network device, i.e. a physical element acting as platform for at least some network services.

“Network services” refer to services relative to the nature of the device. Firewalls and filters analyze and block traffic, routers establish network routes, access controllers admit or not access to the network and services of the network.

The devices may perform their network plane functions, i.e. deliver services that one expects from these.

The devices may also perform functions in the control plane, i.e. they may be accessible for the network administration and/or other devices in the control plane, so as to influence the operation in the network plane.

The control plane portions of the devices may correspond to the functions of a device, which are usually implemented in software, that permit the network administration and/or other devices to establish a state of a device, a group of devices or of the whole network.

The state of the device may include the state of the device per se, i.e. its memory, CPU, thermal and other conditions, the state of its software elements, whether the elements are running, busy, idle, etc., the configuration of the device, and the implication of the device in different services, i.e. its load.

The state of the network plane may provide and maintain user services.

To establish a state of the device, several variables may be read at different devices according to what state is being established and combined by some entity that is about to establish a view on a whole.

All nodes of the communication network may be logical network devices.

At least one of routing of requests in the network, storage and erasure of control data necessary for administering the network, and/or for managing users of the network, may be performed by the control plane portions of the logical network devices without using a centralized server.

The absence of a centralized server may enable to form the network more autonomously. In related art where a central server exists, every device may be required to know the server and to try to connect to it under any circumstances. Devices are usually identified through their network plane identifiers, which are subject to changes.

According to examplary embodiments of the invention, the devices of the network may discover their physical neighborhood (i.e. network plane neighborhood) so as to take their place in the control plane dynamically.

Examplary embodiments of the invention may provide a full plug and play: after some initial configuration of the device, the device may be deployed in the network by the network administration, as is necessary according to the nature of the device and the network plane function of the device (e.g. a router in the middle, an access controller at the edge, etc.). The device may then join the control plane automatically and overtake a part of the control plane load.

Examplary embodiments of the invention may facilitate device deployment but also provide a more robust control plane; in case of failure, the device according to the invention may try all its neighbors in the networks, physical as well as logical neighbors, until the device finds a possibility to communicate its events. The same may go for the access request to the data stored at the devices.

The control data necessary for network administration may be contained in a database distributed between at least a plurality of the control plane portions of the devices of the logical network.

The data necessary for administering the network may comprise data relating to controlling access of a new node to the network, and/or data relating to managing the network, and/or data relating to the configuration of the nodes.

The data necessary for managing the network and users and services of the network may comprise data related to access control of a new node to the network, and/or data related to network management/monitoring, and/or data related to the configuration of devices, including configurations of their logical portions of the control and network planes, and control plane portions of the devices may be organized in a peer-to-peer architecture.

The data necessary for administering the network may comprise addresses to which nodes should make a connection in order to send or receive information.

Data necessary for administering the network includes address information of connection points, inside or outside the network, to which devices should make a connection in order to send or receive data, the connection comprising at least one of logical virtual connections, datagram services and message sending.

The data necessary for managing users of the network may be contained in a database distributed between at least a plurality of the control plane portions of the pieces of equipment of the logical dedicated network.

The database may contain information related to user profiles, AAA profiles for example.

In an exemplary embodiment, database management may be performed using a distributed hash table.

The invention is naturally not limited to the use of distributed hash tables to perform the database management.

Database management may be performed using a distributed algorithm running at least on the devices and providing the logical network organization and a distributed research of the contained data according to various criteria.

Database management may be performed by means of a distributed algorithm using a distributed data structure, in which method, this structure and algorithm forming content addressable logical network.

The distributed research structure may be based on a coordinate space, wherein the devices having control plane portions forming the logical network are responsible for a subspace of the coordinate space.

The coordinate space may be a Cartesian coordinate space.

Each request sent by a device may be associated with coordinates within the coordinate space, and a device receiving a request having coordinates that are not contained in its subspace may transfer the request to a physically or logically neighboring device.

The communication network may comprise nodes comprising at least one of computers, routers, network access controllers and/or switches.

At least one node may provide the role of an access point to any kind of network and/or its services, wireline or wireless network.

The invention is of course not limited to devices providing the role of an access point.

The network may include at least one initiating node, a new node joining the network may send a request that is forwarded to the initiating node, and the initiating node may forward to the new node at least one address of a network node including a device whose control plane portion acts as a part of the logical network.

The new node may send a join request to the received address, and the node receiving the request coming from the new node may deliver to the new node responsibility of a portion of the subspace of the coordinate space for which it is currently responsible.

The node receiving the request coming from the new node may allocate to the new node responsibility for half of the subspace of the coordinate space for which it is responsible.

The new node may include equipment arranged to constitute an access point to a wireless network.

Examplary embodiments of the invention provide a method of extending a communication network comprising a plurality of nodes in the form of connected devices acting as access points, the database containing data needed for network management being distributed between a plurality of the nodes in the form of a distributed structure associated with a coordinate space, each of the plurality of nodes being responsible of a subspace of the coordinate space, which method comprises:

configuring at least one device of the network;

configuring at least one device responsible for data storage, in which method,

the data needed for network management including at least data allowing device identification in the network and data providing security of communications

deploying the new node in the network; and

sharing a subspace of the coordinate space for which the node is responsible between said node and the new node.

The coordinate space may be a Cartesian coordinate space.

A subspace of the coordinate space for which the node is responsible may be shared between said node and the new node by subdividing the subspace into two halves.

At least one network device may own necessary tools/data to play the role of an access point.

Access control to the network may be integrated into a device acting as the link with the user.

Each node may have a view of its neighborhood.

Examplary embodiments of the invention provide a logical network device for operating as a node in a communication network comprising a control plane and a network plane, the network comprising nodes and physical connections of the nodes, the device supporting a control plane portion and a network plane portion in the network plane, the device being configured for forming a logical network with other control plane portions of other logical network devices in a peer to peer fashion, control data necessary for administrating the communications network and/or for managing users of the communication network being contained in a data base distributed between at least the control plane portion of the device and control plane portions of others devices.

Examplary embodiments of the invention provide a communication network comprising at least pieces of equipment that integrate means capable of performing network administration, where network administration comprises particularly, but not exclusively, managing data in the pieces of network equipment, monitoring the network, controlling the network, particularly but not exclusively managing network access control, and the pieces of equipment constituting the network include routers, access controllers, and/or switches.

Preferably, the means for administering the network comprise data enabling users to be identified, configuration parameters for the pieces of equipment of the network, and/or addresses to which the pieces of equipment are to make connections in order to send or receive information.

Advantageously, at least one piece of equipment of the network is provided with means for acting as an access point.

Examplary embodiments of the invention provide a method of communication in a network comprising a plurality of interconnected pieces of equipment, the method comprising the steps of:

configuring at least one piece of equipment of the network, including at least storing data enabling communication to take place between pieces of equipment of the network, said data comprising at least data enabling the piece of equipment in the network to be identified and data for securing exchanges of data;

building the network comprising at least adding a node to the network, and at least sharing tasks between at least some of the pieces of equipment of the network relating to network administration; and

processing data stored in the pieces of equipment, the processing comprising at least operations consisting in enabling each piece of equipment to find data shared between the pieces of equipment of the network, to delete the data if necessary, and/or to record or modify data that has already been stored.

Advantageously, network building comprises a node being added automatically when the node is operational.

It is to be understood that both the foregoing general description and the following detailed description are exemplary, and are intended to provide further explanation of the invention as claimed.

FIG. 1a shows a network using the SNMP architecture;

FIG. 1b shows a network using the AAA architecture;

FIG. 2a shows one possible configuration for a network using the AAA architecture;

FIG. 2b shows another possible configuration for a network using the AAA architecture;

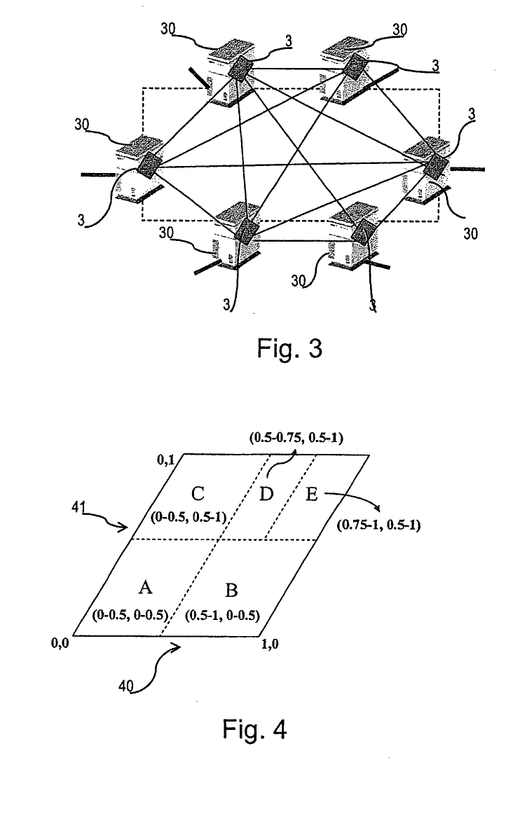

FIG. 3 shows a configuration of the control plane in accordance with the invention;

FIG. 4 shows an example of a two-dimensional CAN table having five nodes;

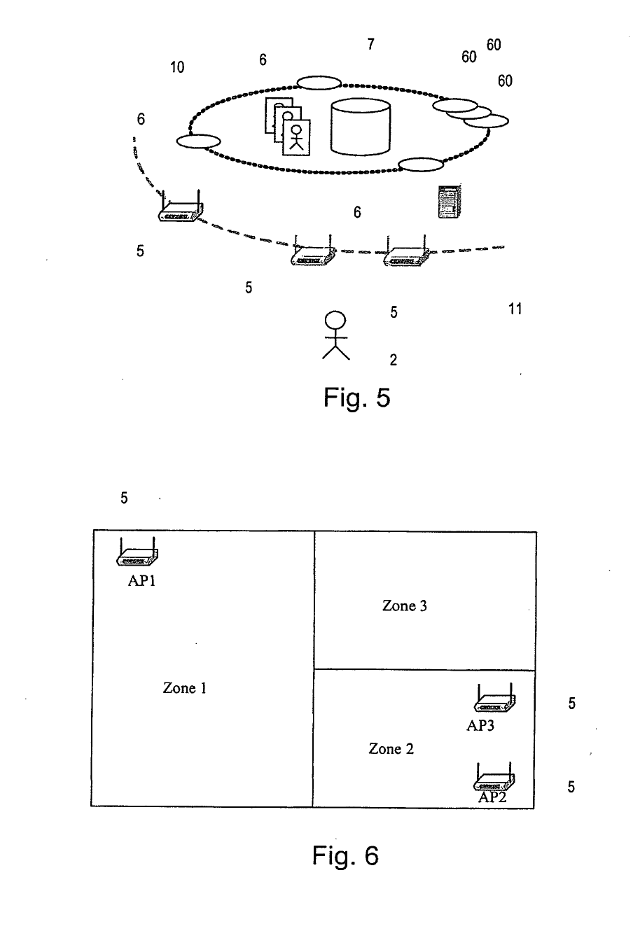

FIG. 5 shows a preferred embodiment of a network of the invention; and

FIG. 6 shows a distribution of management zones in accordance with the invention.

Reference will now be made in detail to embodiments of the invention, examples of which are illustrated in the accompanying drawings.

In order to reduce costs and obtain natural scaling, the pieces of equipment (also referred to as devices) of the network plane are organized directly and deployed so as to create a network comparable to a peer-to-peer (P2P) network, e.g. by storing data relating to access control, to network management, or to entity configuration, as shown in FIG. 3. To do that, the portion of the network equipment control plane (e.g. the AAA client or the SNMP agent) is extended or replaced by a P2P module (3). This P2P module (3) thus contains the necessary data of the control plane.

Given that the resources available in the pieces of equipment (30) of the control plane to perform additional tasks are typically limited, the administrative load is shared between all of the pieces of equipment (30) in the network plane (e.g. routers or access points). Thus, each piece of equipment in the control plane is involved with only a portion of the overall administrative load.

To satisfy the objects of the invention as defined above, network access control is integrated in the piece of equipment that establishes the link with a user. This network access control possesses internal network architecture that develops recent advances in P2P networking. In addition, the P2P network as formed in this way can be used for any conventional task of the control plane such as managing deployed equipment, providing support for mobility, or automatic configuration. To do this, other pieces of equipment or additional P2P loads can be added to the P2P network.

As examplary embodiments, IEEE 802.11 access points could constitute an independent dedicated P2P network storing the distributed user database needed for controlling access to an IEEE 802.1X network.

Examplary implementations of the invention are described below.

In order to satisfy requirements for extendibility and fault tolerance, no entity can have knowledge about the overall network. The basic problem here is not transferring data, but rather locating the data to be transferred.

For example, no access point is authorized to have an index of all of the data records in the coverage. In addition, the broadcasting of data over the network (e.g. “who has data structure X?”) by any piece of equipment is not authorized for reasons of efficiency and extendibility. Finally, in the given environment, broadcasting based on a threshold cannot be accepted, since request iteration can lead to search delays that increase in random manner, waiting times, and generally a quality of service that is reduced. In this context, it is possible for example to make use of distributed hash tables (DHT). They are used for storing and recovering an AAA database that is distributed between access points.

A DHT is a hash table that is subdivided into a plurality of portions. These portions are shared between certain clients then typically forming a dedicated network. Such a network enables the user to store and recover information in (key, data) pairs as illustrated by traditional hash tables known to the person skilled in the art. They require specific rules and algorithms. Well-known examples of distributed hash tables are P2P file sharing networks. Each node forming part of such a P2P network is responsible for a portion of the hash table that is called a “zone”. In this way, there is no longer any need for a central piece of network equipment to manage a complete hash table or its index. Each node participating in such a P2P network manages its portion of the hash table and implements the following primitives: lookup(k), store(k,d), and delete(k).

With lookup(k), a node searches the P2P network for a given hash key k and obtains the data d associated with the key k. Given that each node has only a fraction of the complete hash table, it is possible that k does not form part of the fraction in the node. Each distributed hash table thus defines an algorithm for searching for the particular node n responsible for k, given that this is achieved on a hop-by-hop basis with each hop “closer” to n, constituted by the routing algorithm of the distributed hash table, as known to the person skilled in the art.

The primitive store(k,d) stores an tuple comprising a key k and the associated data value d in the network, i.e. (k,d) are transmitted to a node responsible for k using the same routing technique as with lookup.

With delete(k), an entry is deleted from the hash table, i.e. the node responsible for k deletes (k,d).

P2P-based dedicated networks use their own mechanisms for routing or transferring data. They are thus optimized in such a manner that node has only a very local view of its network neighborhood. This property is necessary for good scaling since state per node does not necessarily increase with network growth. Routing is deterministic and there are upper limits on the number of hops that a request can make. Most P2P networks present behavior that is logarithmic with total number of nodes.

An example of a DHT that is suitable for use is of the content addressable network (CAN) type. CAN defines a user interface for a standard hash table as described above. The CAN network proposes dedicated building mechanisms (node junction/node initiation), node exit mechanisms, and routing algorithm mechanisms. The index of the CAN network hash table is a Cartesian coordinate space of dimension d on a d-torus. Each node is responsible for a portion of entire coordinate space. FIG. 4 shows an example of a CAN network having two dimensions and five nodes (A, B, C, D, and E). In the CAN network, each node contains the zone database that corresponds to the coordinate space allocated thereto, together with a dedicated neighborhood table. The size of the table depends solely on the dimension d. The standard mechanism for allocating a zone leads to the index being shared uniformly between nodes. By default, the CAN network uses a dedicated building procedure (known as initiating) based on a well-known domain name system (DNS) address. This enables each node joining the network to obtain an address from one or more initiating nodes of the CAN network. On receiving a request from a new node, an initiating node responds merely with the Internet protocol (IP) addresses of a plurality of randomly-selected nodes that are to be found in the coverage. The junction request is then sent to one of those nodes. The new node then selects randomly an index address and sends a junction request for that address to one of the received Is addresses. The CAN network uses its routing algorithm to route that request to the node responsible for the zone from which the address depends. The node in question then splits its zone into two halves and conserves one of the halves, the database of the link zone, and the list of neighbors derived from node joining the network.

For example, the CAN network in FIG. 4 is one possible result of the following scenario:

A is the first node and contains the entire database;

B joins the network and obtains half of the zone A, halving on the x axis (40);

C joints the network and obtains randomly half of the zone A, halving on the y axis (41);

D joins the network and obtains randomly half of the zone B, halving on the y axis (41); and

E joins the network and obtains randomly half of the zone D, halving on the x axis (40).

Routing in the CAN network is based on a considerable amount of transfer. Each request contains a destination point in the index base. Each receiver node that is not responsible for the destination point transfers the request to one of its neighbors having coordinates that are closer to the destination point than its own coordinates.

To improve performance (eliminating latency, obtaining better reliability), the CAN network may present various parameters:

Adjusting the dimension d: the number of possible paths increases with dimension, thus leading to better protection against node failure. The length of the overall path decreases with d.

Number of independent realities r: by using a plurality of independent CAN indices r within a CAN network, the nodes r are responsible for the same zone. The length of the overall path decreases with r (since routing can take place in all of the realities in parallel and can be abandoned in the event of success). The number of paths actually available increases. The availability of data increases since the database is replicated r times.

Using different measures, reproducing the topology in the CAN network: the CAN network can use a different routing measure. The underlying topology can be reproduced in the coverage.

Node traffic exchange: the same zone can be allocated to a group of nodes, thus producing the number of zones and the length of the overall path.

The use of a plurality of hashing functions: this is comparable to having a plurality of realities, given that each hashing function constructs a parallel index entry.

Caching and replicating data pairs: “popular” pairs can be cached by the nodes and thus replicated in the database.

FIG. 5 shows another implementation of a decentralized management architecture for a WLAN in accordance with the 802.11 standard, showing how access control and decentralized management may be integrated in an existing population access technology. This example is based on standard transmission control protocol/Internet protocol (TCP/IP) known to the person skilled in the art and implemented in the central network. The P2P management network is made up of access points (5) complying with the 802.11 standard. Each access point (5) acts as a P2P node (6) forming a logical dedicated network (8) on the physical central network. This coverage stores different logical databases, mainly management and user databases (7). The user database stores AAA type user profiles. The management database assists the administrator in managing all of the connected access points and stores the access point parameters expressed in the respective syntax (e.g. MIB 802.11 variables, parameters of the proprietary manufacturer). At the request of the user, the node in question recovers the corresponding profile. By means of the recovered profile, the serving access point (5) follows the usual 802.1X standard procedure as authenticator with a local authentication server. In addition, it is possible to include an arbitrary number of assistant auxiliary nodes (60), e.g. the console of the network administrator, in the P2P network. All of the nodes (5, 6) participating in the P2P network interact with one another to route requests and to recover, store, and delete data. The P2P network is accessible from any connected access point.

With n access points and no central equipment, it is practical to express this confidence relationship by means of public key cryptography making use of signed certificates, for example, serving to protect the setting up of communication between two participates at any moment, with n secrets for n nodes. The defined identity of an access point is the MAC address of its wired interface connected to the CAN.

Each access point requires a minimum configuration before being deployed in the network. This is necessary mainly for secure management access at the access point.

The confidence relationship with the access point is represented by installing a signed certificate on each access point. In addition, the administrator defines a local administration connection (user/password pair) and sets the usual 802.11 parameters (SSID, authentication node, channels and outlets used). Finally, the administrator provides the initiating address of the dedicated network and deploys the access point by installing it at the desired location and by connecting it to the network.

The network may thus be configured in such a manner as to balance task loading: if an access point is loaded heavily, the administrator may install an additional access point nearby. If the access points in question are not neighbors in the CAN, they share only the 802.11 traffic load. If the access points are neighbors of the CAN, they also share the administrative load. This is represented in FIG. 6 which shows three access points (5) installed in a large hall. To begin with, the initially installed access point (AP1) has the entire index. When access point 2 arrives, AP1 gives half of its zone to access point 2 (AP2), thus becoming its dedicated neighbor (but not necessarily its physical neighbor). If the user data traffic is particularly high in the bottom right-hand corner of the map and relatively low in the top left-hand corner, the administrator might add access point 3 (AP3) in the topological vicinity of access point 2 in order to handle the high wireless traffic load. If coverage is associated with the topology of the network, the new AP3 automatically becomes a dedicated neighbor of AP2. Thus, it obtains half of the zone database managed by AP2 (zone 3). Consequently, assuming that the administrator is attempting to balance traffic load using this approach, the zone sizes of access points decrease in zones having high traffic load, thereby releasing system capacity for handling traffic. In contrast, the zone AP1 remains relatively large, but this is justified by its lower traffic load. Naturally, there exists a compromise between excess zone management database and WLAN traffic load.

Thus, instead of having all of the data needed for administering the network stored in a single database of a central server, the data is shared between the various pieces of equipment in the network. Thus, a network acting as an access point searches for the data it does not have in the various pieces of equipment of the network.

Given that the number of elements in the network plane is selected as a function of traffic load, and providing the administrative load is properly shared between the elements of the network plane, then the control plane may also be scaled. For example, increasing the number of 802.11 access points to satisfy requirements in terms of traffic may automatically activate management of a larger number of users. Given that there is no central element that might progressively increase overall cost, this solution may also be used in networks that are very small. A larger network may be constructed merely by adding additional elements to the network plane, e.g. 802.11 access points. This solution thus automatically follows natural growth of the network and is quite suitable for being adapted to very large networks.

It is also possible to envisage storing data several times over in pieces of equipment of the network. Each piece of equipment thus contains two databases. The data contained in the first database is different from the data contained in the second database. In this way, if a piece of equipment breaks down, its data may be found in the other pieces of equipment.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of managing a communication network comprising a control plane and a network plane, the network comprising nodes and physical connections of the nodes, each of a plurality of nodes being a logical network device, supporting a control plane portion in the control plane and a network plane portion in the network plane, in which method, the control plane portions of the logical network devices form a logical network in a peer to peer fashion, and control data necessary for administering the communication network and/or for managing users of the communication network is contained in at least one database distributed between at least a plurality of control plane portions of the network devices forming the logical network.

2. A method according to claim 1, wherein all nodes of the communication network are each a logical network device.

3. A method according to claim 1, wherein at least one of routing of requests in the network, storage and erasure of control data necessary for administering the network, and/or for managing users of the network, are performed by the control plane portions of the logical network devices without using a centralized server.

4. A method according to the claim 2, wherein the control data necessary for network administration is contained in a database distributed between at least a plurality of the control plane portions of the devices of the logical network.

5. A method according to claim 3, wherein the data necessary for administering the network comprises data relating to controlling access of a new node to the network, and/or data relating to managing the network, and/or data relating to the configuration of the nodes.

6. A method according to claim 5, wherein the data necessary for managing the network and users and services of the network comprises data related to access control of a new node to the network, and/or data related to network management/monitoring, and/or data related to the configuration of devices, including configurations of their logical portions of the control and network planes, in which method, control plane portions of the devices are organized in a peer-to-peer architecture.

7. A method according to claim 6, wherein the data necessary for administering the network comprises addresses to which nodes should make a connection in order to send or receive information.

8. A method according to claim 6, wherein data necessary for administering the network includes address information of connection points, inside or outside the network, to which devices should make a connection in order to send or receive data, the connection comprising at least one of logical virtual connections, datagram services and message sending.

9. A method according to claim 1, wherein the data necessary for managing users of the network is contained in a database distributed between at least a plurality of the control plane portions of the pieces of equipment of the logical dedicated network.

10. A method according to claim 9, wherein the database contains information related to user profiles.

11. A method according to claim 1, wherein database management is performed using a distributed hash table.

12. A method according to claim 1, wherein database management is performed using a distributed algorithm running at least on the devices and providing the logical network organization and a distributed research of the contained data according to various criteria.

13. A method according to claim 1, wherein database management is performed by means of a distributed algorithm using a distributed data structure, in which method, this structure and algorithm form content addressable logical network.

14. A method according to claim 13, wherein the distributed research structure is based on a coordinate space, wherein the devices having control plane portions forming the logical network are responsible for a subspace of the coordinate space.

15. A method according to claim 14, wherein the coordinate space is a Cartesian coordinate space.

16. A method according to claim 14, wherein each request sent by a device is associated with coordinates within the coordinate space, and wherein a device receiving a request having coordinates that are not contained in its subspace transfers the request to a physically or logically neighboring device.

17. A method according to claim 1, wherein the communication network comprises nodes comprising at least one of computers, routers, network access controllers and/or switches.

18. A method according to claim 1, wherein at least one node provides the role of an access point to any kind of network and/or its services, wireline or wireless network.

19. A method according to claim 14, the network including at least one initiating node, in which method a new node joining the network sends a request that is forwarded to the initiating node, and the initiating node forwards to the new node at least one address of a network node including a device whose control plane portion acts as a part of the logical network.

20. A method according to claim 14, wherein the new node sends a join request to the received address, and wherein the node receiving the request coming from the new node delivers to the new node responsibility of a portion of the subspace of the coordinate space for which it is currently responsible.

21. A method according to claim 20, wherein the node receiving the request coming from the new node allocates to the new node responsibility for half of the subspace of the coordinate space for which it is responsible.

22. A method according to claim 19, in which the new node includes equipment arranged to constitute an access point to a wireless network.

23. A method of extending a communication network comprising a plurality of nodes in the form of connected devices acting as access points, the database containing data needed for network management being distributed between a plurality of the nodes in the form of a distributed structure associated with a coordinate space, each of the plurality of nodes being responsible of a subspace of the coordinate space, which method comprises:
configuring at least one device of the network;
configuring at least one device responsible for data storage, the data needed for network management including at least data allowing device identification in the network and data providing security of communications
deploying the new node in the network; and
sharing a subspace of the coordinate space for which the node is responsible between said node and the new node.

24. A method according to claim 23, wherein the coordinate space is a Cartesian coordinate space.

25. A method according to claim 23, wherein a subspace of the coordinate space for which the node is responsible is shared between said node and the new node by subdividing the subspace into two halves.

26. A method according to claim 23 wherein at least one network device owns necessary tools/data to play the role of an access point.

27. A method according to claim 23 wherein access control to the network is integrated into a device acting as the link with the user.

28. A method according to claim 23 wherein each node has a view of its neighborhood.

29. A logical network device for operating as a node in a communication network comprising a control plane and a network plane, the network comprising nodes and physical connections of the nodes, the device supporting a control plane portion in the control plane and a network plane portion in the network plane, the device being configured for forming a logical network with other control plane portions of other logical network devices in a peer to peer fashion, control data necessary for administrating the communications network and/or for managing users of the communication network being contained in a database distributed between at least the control plane portion of the device and control plane portions of others devices.
